(19) United States
(12) Patent Application Publication
(10) Pub. No.: US 2005/0267008 A1
(43) Pub. Date: Dec. 1, 2005

(54) Laundry treatment compositions

(75) Inventors: Melvin Carvell, Wirral (GB); Christopher Clarkson Jones, Wirral (GB); Giovanni Francesco Unali, Wirral (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division of Conopco, Inc.

(21) Appl. No.: 11/137,865

(22) Filed: May 26, 2005

(30) Foreign Application Priority Data
May 28, 2004 (GB) 0411995.4

(51) Int. Cl. C11D 3/00

(52) U.S. Cl. 510/511

(57) ABSTRACT

Compositions comprising a water-soluble or dispersible modified polysaccharide, which preferably has a backbone comprising β₁₋₄ linkages, which has a hydrophobic agent bonded thereto by a hydrolytically stable bond, and a sugar polyester. The specification also discloses laundry treatment compositions comprising these compositions.

### TECHNICAL FIELD

The present invention relates to compositions comprising modified polysaccharides and sugar polyesters. These compositions are suitable, for example, for use as laundry treatment compositions or as components thereof. Laundry treatment compositions containing compositions according to the invention, provide softening benefits to fabric. The invention further relates to a method of depositing a sugar polyester from solution or dispersion, onto a substrate by means of such a composition.

### BACKGROUND OF THE INVENTION

Compositions which are capable of imparting softening to substrates such as fabric, hair and skin are well known in the art. To date, silicones and related compounds are widely used as softening agents.

However, despite its excellent softening properties, silicone has a number of inherent disadvantages associated with it, hence the need exists for new softening compounds that don't have the disadvantages of silicones.

In the context of laundry products, the low biodegradable nature of silicone is a notable disadvantage and one which increases in significance as environmental legislation continues to get tougher. Therefore, to find alternatives to silicone which are more biodegradable is a widely sought after goal. Another problem often encountered when using silicones as softeners in laundry is that although they increase the soft feel of a fabric they decrease the fabric's absorbency. A decrease in the absorbency properties of a fabric means that its ability to take up water decreases—this is particularly problematic for towels and is strongly disliked by the consumer. Further, cost reduction is an ever present goal across the industry and cheaper alternatives to silicones as softeners are thus sought after.

The improvement of these aspects without a consequential loss in softening capability is clearly desirable.

### PRIOR ART

WO-A-00/18861 provides a water-soluble or water-dispersible polysaccharide which comprises: a deposition enhancing part (the polymeric backbone—which in the case of cellulose shows self-recognition properties) and a benefit agent group, which may be a softening agent, attached to the deposition enhancing part by a hydrolytically stable bond. During a treatment process the material undergoes a chemical change which does not involve the hydrolytically stable bond but by which the affinity of the material onto the substrate is increased. A preferred material is cellulose mono acetate (CMA). This molecule has an affinity for cotton due to the self-recognition properties of cellulose and is soluble due to the presence of acetate groups. The acetate groups hydrolyse in aqueous solution causing the deposited cellulose to remain on a cellulosic substrate. Manufacture of CMA involves excessive esterification of the —OH groups of the cellulose and then hydrolysis of some of the esters to attain the desired degree of esterification.

Our UK patent application no. GB 0121148 discloses a substituted β₁₋₄ linked polysaccharide such as cellulose mono-acetate with one or more independently selected silicone chains covalently attached to it as the benefit agent.

While the molecules of GB 0121148 are relatively expensive, it has been found that the covalently-linked silicone chains may be used to emulsify droplets of a further portion of silicone to enhance the deposition of that material.

Our UK patent application no GB 0123380 discloses a laundry treatment composition comprising a composition similar to that of GB 0121148 in combination with a non-covalently bonded silicone which is, for example, emulsified in the same composition. This enables relatively large quantities of silicone to be deposited without an excessive on-cost for the formulator.

Our co-pending patent application, GB 0313900, discloses a non-hydrolysable polysaccharide, with a textile benefit species bonded thereto by a hydrolytically stable bond. A further benefit species may also be present. Silicone is both preferred and exemplified as both benefit species. Despite the above-mentioned advances, the need remains to further improve upon such deposition systems. It is advantageous to reduce cost, improve the biodegradability of the material and improve absorbency without compromising the softening effect.

It has now surprisingly been found that compositions comprising a water-soluble or dispersible polysaccharide having a hydrophobic agent bonded thereto by a hydrolytically stable bond and a sugar polyester give benefits of improved biodegradability, lower cost and less hydrophobing without any loss of softening benefit.

### DEFINITION OF THE INVENTION

According to a first aspect of the invention, there is provided a composition comprising:
(a) a water-soluble or dispersible polysaccharide having a hydrophobic agent bonded thereto by a hydrolytically stable bond and
(b) a sugar polyester (SPE).

A second aspect of the invention provides a laundry treatment composition comprising: from 1 to 60% by weight of the total composition of a surfactant, and from 0.001 to 25% by weight of the total composition of an emulsion comprising (a) a water-soluble or dispersible polysaccharide selected from the group consisting of poly-glucan, poly-mannan, gluco-mannan and mixtures thereof, said polysaccharide having a hydrophobic agent bonded thereto by a hydrolytically stable bond, and (b) a sugar polyester.

According to a third aspect of the invention, there is provided a method for depositing a sugar polyester onto a substrate, the method comprising, contacting in an aqueous medium, the substrate and a composition according to the first aspect of the invention.

A fourth aspect of the invention provides a use of composition according to the first aspect of the invention in a laundry treatment composition to provide a softening benefit to a substrate.

The invention further provides emulsions comprising compositions according to the first aspect as a dispersed phase. Ideally, these emulsions may be dried or otherwise encapsulated, to provide a dispersible form of the compositions of the invention. The dispersible form can comprise an adjunct, preferably a granulate, suitable for inclusion in a laundry composition.

Fully formulated laundry compositions according to the present invention preferably contain a surfactant (which may be nonionic, anionic, cationic, or a mixture of some or all thereof). Preferably the surfactant is a detersive surfactant, more preferably an anionic or nonionic surfactant or a mixture thereof.

Typically, the level of the modified polysaccharide (i.e. the polysaccharide with hydrophobic agent bonded thereto) and SPE in a fully formulated composition will be from 0.001 to 25 percent (%) by weight of the fully formulated composition.

### DETAILED DESCRIPTION OF THE INVENTION

As set out above, the composition of the present invention comprises a polysaccharide which is water-soluble or water-dispersible in nature and which has a hydrophobic agent, which is attached to the polysaccharide by a hydrolytically stable bond, and which in a preferred embodiment is a silicone. The composition further comprises a sugar polyester (SPE). The SPE may or may not be chemically bonded to the polysaccharide. Furthermore, some of the SPE may be chemically bonded to the polysaccharide, whilst some is not.

The invention will be described below in respect of various embodiments.

For the sake of clarity, the term “modified polysaccharide” as used herein means the polysaccharide having the hydrophobic agent bonded thereto.

The Polysaccharide

The water-soluble or dispersable polysaccharide is preferably a β-_{1,4}-linked polysaccharide having an affinity for cellulose.

The polysaccharide may be hydrolysable or non-hydrolysable.

By hydrolysable polysaccharide is meant that the polysaccharide contains a deposition enhancing group which undergoes a chemical change under conditions (including temperature) of use to increase the affinity of the polysaccharide for a substrate. In those embodiments of the invention intended for aqueous treatment of substrates, such as in a wash liquor, these conditions can include elevated pH and/or temperatures above ambient. By non-hydrolysable polysaccharide is meant that the polysaccharide does not contain such a deposition enhancing group.

By an increase in the affinity of the polysaccharide for a substrate (such as a textile fabric) upon a chemical change, is meant that at some time during the treatment process, the amount of material that has been deposited is greater when the chemical change is occurring or has occurred, compared to when the chemical change has not occurred and is not occurring, or is occurring more slowly, the comparison being made with all conditions being equal except for that change in the conditions which is necessary to affect the rate of chemical change.

By water-soluble, as used herein, is meant is that the material forms an isotropic solution on addition to water or another aqueous solution.

By water-dispersible, as used herein, is meant is that the material forms a finely divided suspension on addition to water or another aqueous solution.

Deposition onto a substrate includes deposition by adsorption, co-crystallisation, entrapment and/or adhesion.

The polysaccharide may be straight or branched. Many naturally occurring polysaccharides have at least some degree of branching, or at any rate at least some saccharide rings are in the form of pendant side groups on a main polysaccharide backbone.

A polysaccharide comprises a plurality of saccharide rings which have pendant hydroxyl groups. In the preferred polysaccharides of the present invention, at least some of these hydroxyl groups are independently substituted by, or replaced with, one or more other substituents, at least one being a hydrophobic agent. In our preferred class of materials the hydrophobic agent is a silicone chain. The “average degree of substitution” for a given class of substituent means the average number of substituents of that class per saccharide ring for the totality of polysaccharide molecules in the sample and is determined for all saccharide rings.

Deposition Enhancing Groups

By deposition enhancing group is meant a group which undergoes a chemical change under conditions of use to increase the affinity of the polysaccharide for a substrate. The deposition enhancing group is attached to the polysaccharide agent group by means of a chemical bond.

The average degree of substitution of these pendant groups which undergo the chemical change is preferably from 0.1 to 3 (e.g. from 0.3 to 3), more preferably from 0.1 to 1 (e.g. from 0.3 to 1).

The chemical change which causes the increased substrate affinity is preferably caused by hydrolysis, perhydrolysis or bond-cleavage, optionally catalysed by an enzyme or another catalyst. Hydrolysis of substituent ester-linked groups is typical.

By ester linkage is meant that the hydrogen of an —OH group, present on the polysaccharide backbone, has been replaced by a substituent such as R′—CO—, R′SO₂— etc to form a carboxylic acid ester, sulphonic acid ester (as appropriate) etc together with the remnant oxygen attached to the saccharide ring. In some cases, the group R′ may for example contain a heteroatom, e.g. as an —NH— group attached to the carbonyl, sulphonyl etc group, so that the linkage as a whole could be regarded as a urethane etc linkage. However, the term ester linkage is still to be construed as encompassing these structures. Thus, the deposition enhancing groups have the general formula (I):—
—OR
where the oxygen is the remnant oxygen from the —OH group attached to the saccharide ring, and
where the R groups are independently selected from groups of formulae:— 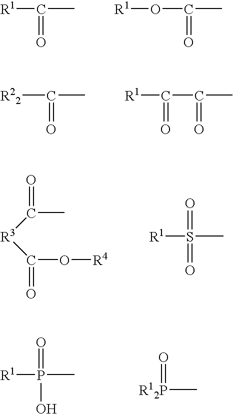
wherein each R¹ is independently selected from C₁₋₂₀ (preferably C₁₋₆) alkyl, C₂₋₂₀ (preferably C₂₋₆) alkenyl (e.g. vinyl) and C₅₋₇ aryl (e.g. phenyl) any of which is optionally substituted by one or more substituents independently selected from C₁₋₄ alkyl, C₁₋₁₂ (preferably C₁₋₄) alkoxy, hydroxyl, vinyl and phenyl groups;
each R² is independently selected from hydrogen and groups R¹ as hereinbefore defined;
R³ is a bond or is selected from C₁₋₄ alkylene, C₂₋₄ alkenylene and C₅₋₇ arylene (e.g. phenylene) groups, the carbon atoms in any of these being optionally substituted by one or more substituents independently selected from C₁₋₁₂ (preferably C₁₋₄) alkoxy, vinyl, hydroxyl, halo and amine groups;
each R⁴ is independently selected from hydrogen, counter cations such as alkali metal (preferably Na) or ½Ca or ½Mg, and groups R¹ as hereinbefore defined; and
groups R which together with the oxygen atom forming the linkage to the respective saccharide ring forms an ester or hemi-ester group of a tricarboxylic- or higher polycarboxylic- or other complex acid such as citric acid, an amino acid, a synthetic amino acid analogue or a protein;
any remaining R groups being selected from hydrogen and other substituents.

Some of the R groups may optionally have one or more structures, for example as hereinbefore described. For example, one or more R groups may simply be hydrogen or an alkyl group.

Preferred groups which undergo the chemical change may for example be independently selected from one or more of acetate, propanoate, trifluroacetate, 2-(2-hydroxy-1-oxopropoxy) propanoate, lactate, glycolate, pyruvate, crotonate, isovalerate cinnamate, formate, salicylate, carbamate, methylcarbamate, benzoate, gluconate, methanesulphonate, toluene, sulphonate, groups and hemiester groups of fumaric, malonic, itaconic, oxalic, maleic, succinic, tartaric, aspartic, glutamic, and malic acids.

Particularly preferred such groups are the monoacetate, hemisuccinate, and 2-(2-hydroxy-1-oxopropoxy)propanoate. The term “monoacetate” is used herein to denote those acetates with the degree of substitution of less than 1 and greater than 0.4 on a cellulose or other β-1,4 polysaccharide backbone.

Cellulose esters of hydroxyacids can be obtained using the acid anhydride in acetic acid solution at 20-30° C. and in any case below 50° C. When the product has dissolved the liquid is poured into water (b.p. 316,160). Tri-esters can be converted to secondary products as with the triacetate. Glycollic and lactic ester are most common.

Cellulose glycollate may also be obtained from cellulose chloracetate (GB-A-320 842) by treating 100 parts with 32 parts of NaOH in alcohol added in small portions.

An alternative method of preparing cellulose esters consists in the partial displacement of the acid radical in a cellulose ester by treatment with another acid of higher ionisation constant (FR-A-702 116). The ester is heated at about 100° C. with the acid which, preferably, should be a solvent for the ester. By this means cellulose acetate-oxalate, tartrate, maleate, pyruvate, salicylate and phenylglycollate have been obtained, and from cellulose tribenzoate a cellulose benzoate-pyruvate. A cellulose acetate-lactate or acetate-glycollate could be made in this way also. As an example cellulose acetate (10 g.) in dioxan (75 ml.) containing oxalic acid (10 g.) is heated at 100° C. for 2 hours under reflux.

Multiple esters are prepared by variations of this process. A simple ester of cellulose, e.g. the acetate, is dissolved in a mixture of two (or three) organic acids, each of which has an ionisation constant greater than that of acetic acid (1.82×10⁻⁵). With solid acids suitable solvents such as propionic acid, dioxan and ethylene dichloride are used. If a mixed cellulose ester is treated with an acid this should have an ionisation constant greater than that of either of the acids already in combination.

A cellulose acetate-lactate-pyruvate is prepared from cellulose acetate, 40 percent. acetyl (100 g.), in a bath of 125 ml. pyruvic acid and 125 ml. of 85 percent. lactic acid by heating at 100° C. for 18 hours. The product is soluble in water and is precipitated and washed with ether-acetone. M.p. 230-250° C.

Other Substituents

As well as the hydrophobic agent and optional deposition enhancing groups, pendant groups of other types may optionally be present, i.e. groups which do not confer a softening benefit and which do not undergo a chemical change to enhance substrate affinity. Within that class of other groups is the sub-class of groups for enhancing the solubility of the material (e.g. groups which are, or contain one or more free carboxylic acid/salt and/or sulphonic acid/salt and/or sulphate groups).

Examples of solubility enhancing substituents include carboxyl, sulphonyl, hydroxyl, (poly)ethyleneoxy- and/or (poly)propyleneoxy-containing groups, as well as amine groups.

The other pendant groups preferably comprise from 0% to 65%, more preferably from 0% to 10% of the total number of pendant groups. The water-solubilising groups could comprise from 0% to 100% of those other groups but preferably from 0% to 20%, more preferably from 0% to 10%, still more preferably from 0% to 5% of the total number of other pendant groups.

A preferred group of polysaccharides (locust bean gum, for example) have pendant galactose or other sugar residues which make them effectively more water dispersible/soluble than unmodified cellulose, but which are not hydrolysed from the backbone under conditions of use.

Preferably, the polysaccharide has a backbone comprising β₁₋₄ linkages. More preferably it is a poly-glucan, poly-mannan, or gluco-mannan or mixtures thereof and most preferably a galacto-mannan or xylo-glucan or mixtures thereof. A particularly preferred group of polysaccharides is Locust Bean Gum, Tamarind xyloglucan, and guar gum or mixtures thereof. In a further preferred embodiment the polysaccharide is cellulose monoacetate.

The Sugar Polyester (SPE)

The composition of the invention further comprises a sugar polyester (SPE). The SPE may or may not be chemically bonded to the polysaccharide. Preferably, the SPE is not chemically bonded to the polysaccharide. In a further embodiment, some of the SPE is chemically bonded to the polysaccharide, whilst some is not.

By chemically bonded is meant the SPE is attached by a chemical bond (such as a covalent bond or an ionic bond) to the polysaccharide.

That sugar polyester which is not chemically bonded to the polysaccharide may be bonded thereto by a physical bond (such as hydrogen bonds, van der waal forces, hydrophobic interactions, electrostatic interactions, etc).

In the embodiment of the invention where some SPE is bonded to the polysaccharide by a chemical bond and some is not, the ratio of sugar polyester which is bonded to the polysaccharide by a chemical bond to that sugar polyester which is not bonded by a chemical bond is in the range of from 1:1000 to 1:1 and preferably from 1:200 to 1:4.

The sugar polyester is preferably selected from the group consisting of sucrose polyesters, glucose polyesters and cellobiose polyesters, and is most preferably a sucrose polyester.

Preferably, the ratio of the polysaccharide with the hydrophobic agent bonded thereto to the SPE is in the range of from 1:200 to 1:5 and most preferably from around 1:20 to 1:8 parts by weight of the composition.

Deposition of SPE onto a substrate includes deposition by adsorption, co-crystallisation, entrapment and/or adhesion.

The Hydrophobic Agent

The hydrophobic agent is one that renders the material more surface active than the polysaccharide alone. By surface active is meant that the material tends to accumulate at oil/water interfaces and lower their surface tension.

The hydrophobicity should not be so great as to prevent the dissolution or dispersion of the polysaccharide in water.

The hydrophobic agent is preferably selected from the group consisting of silicone, hydrocarbon and hydrophobic polymer. In one embodiment the hydrophobic agent is a silicone.

The hydrophobic agent is attached to the polysaccharide by a stable bond. That means that the bonding of the hydrophobic agent should be sufficiently stable so as not to undergo hydrolysis during processing or on storage prior to use or in the environment of the treatment process for the duration of that process. For example, in laundry cleaning applications, the bond between the hydrophobic agent and polysaccharide should be sufficiently stable so that it does not undergo hydrolysis in the wash liquor, at the wash temperature, before the SPE has been deposited onto the fabric.

Preferably, the bond between the hydrophobic agent and the polysaccharide is such that the decay rate constant (k_{d}) of the material in an aqueous solution at 0.01 wt % of the material together with 0.1 wt % of anionic surfactant at a temperature of 40° C. at a pH of 10.5 is such that
k_{d}<10⁻³s⁻¹.
Silicone Chain(s) as Hydrophobic Agent

In a preferred embodiment the hydrophobic agent is a silicone selected from polydialkyl siloxanes, amine derivatives thereof, and mixtures thereof wherein the silicone comprises silicone chains.

As used herein the term “silicone chain” means a polysiloxane or derivative thereof.

The number average molecular weight (Mₙ) of the polysaccharide backbone may typically be in the range of 1,000 to 600,000, for example 2,000 to 400,000, e.g. as measured using GPC with multiple-angle, laser-scattering detection.

Preferably, the average degree of substitution for the silicone chains on the polysaccharide backbone is from 0.00001 to 0.5, more preferably 0.0001 to 0.5, still more preferably from 0.001 to 0.1 and even more preferably from 0.001 to 0.05.

Preferred silicone chains suitable for this use are those of formula: 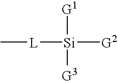
wherein L is absent or is a linking group and one or two of substituents G¹-G³ is a methyl group, the remainder being selected from groups of formula 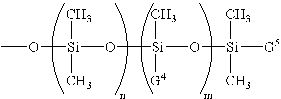
the —Si(CH₃)₂O— groups and the —Si(CH₃O)(G⁴)- groups being arranged in random or block fashion, but preferably random.
wherein n is from 5 to 1000, preferably from 10 to 200 and m is from 0 to 100, preferably from 0 to 20, for example from 1 to 20.

G⁴ is selected from groups of formula:
—(CH₂)ₚ—CH₃, where p is from 1 to 18
—(CH₂)_{q}—NH—(CH₂)ᵣ, —NH₂ where q and r are independently from 1 to 3
—(CH₂)ₛ—NH₂, where s is from 1 to 3 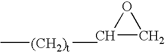
   where t is from 1 to 3
—(CH₂)ᵤ—COOH, where u is from 1 to 10, 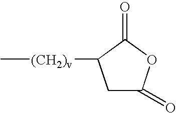
   where v is from 1 to 10, and
—(CH₂CH₂O)_{w}—(CH₂)ₓH, where w is from 1 to 150, preferably from 10 to 20 and x is from 0 to 10;
and G⁵ is independently selected from hydrogen, groups defined above for G⁴, —OH, —CH₃ and —C(CH₃)₃.
   Synthetic Routes

Silicone chains as hydrophobic agent are preferably attached via a linking group “-L-”. This linking group is the residue of the reactants used to form the bond between the hydrophobic agent and the polysaccharide.

For silicone chains as hydrophobic agent, one or more hydroxyl groups on the polysaccharide are reacted with a reactive group attached to the silicone chain, or the hydroxyl group(s) in question is/are converted to another group capable of reaction with a reactive group attached to the silicone chain.

Listed below, are suitable mutually reactive groups. In the case of hydroxyl groups, these may be the original hydroxyl group of the polysaccharide. However, either of a pair of these mutually reactive groups may be present on the polysaccharide and the other attached to the silicone chain, or vice versa, the reaction chemistry being chosen appropriately.

In the following description, for convenience, “PSC” refers to the polysaccharide chain with or without deposition enhancing group(s) and/or other substituent(s) already attached. “SXC” refers to the group:— 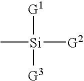
as defined above.

Preferred linking groups -L- are selected from the following, wherein preferably, the left hand end of the group depicted is connected to the saccharide ring either direct or via the residual oxygen of one of the original saccharide —OH groups and the right hand end is connected to the moiety —Si(G¹G²G³). Thus, the configuration as written is PSC-L-SXC. However, the reverse configuration SXC-L-PSC is also within the ambit of this definition and this is also mentioned where appropriate.

Preferred linking groups -L- are selected from amide, ester, ether, urethane, triazine, carbonate, amine and ester-alkylene linkages.

A preferred amide linkage is: 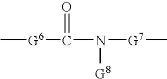
where G⁶ and G⁷ are each optionally present and are independently selected spacer groups, e.g. selected from C₁₋₁₄ alkylene groups, arylene, C₁₋₄ alkoxylene, a residue of an oligo- or poly-ethylene oxide moiety, C₁₋₄ alkylamine or a polyamine groups and
G⁸ is hydrogen or C₁₋₄ alkyl.

This linkage can be formed by reacting 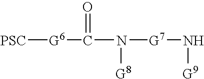
wherein G⁷ and G⁸ are as hereinbefore defined and G⁹ is hydrogen or C₁₋₄ alkyl;
with a compound of formula: 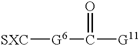
   wherein G¹¹ is hydroxy, a group with active ester functionality halo, or a leaving group suitable for neucleophilie displacement such as imidazole or an imidazole-containing group and wherein G⁶ is hereinbefore defined above, or —CO-G¹¹ is replaced by a cyclic acid anhydride. Active ester synthesis is described in M. Bodanszky, “The Peptides”, Vol. 1, Academic Press Inc., 1975, pp 105 ff.

The reverse configuration linkage may be formed by reacting 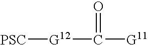
wherein G¹² is a ring-opened carboxylic acid anhydride, phenylene, or a group of formula 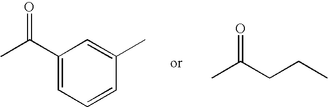
and G¹¹ is as hereinbefore defined;
with the group of formula 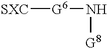
where G⁶ and G⁸ are as hereinbefore defined.

A preferred ester linkage has the formula 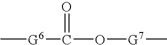
wherein G⁶ and G⁷ are as hereinbefore defined, G⁶ optionally being absent.

This may be formed by reacting 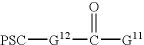
wherein G¹¹ and G¹² are as hereinbefore defined with
SXC-G⁶-OH
wherein G⁶ is as hereinbefore defined.

The reverse ester linkage formation may be formed by reacting
PSC-G⁷-OH
(i.e. the polysacharide with optional G⁷ and at least one residual —OH group) with 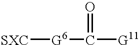
wherein G⁶ and G¹¹ are as hereinbefore defined, or —CO-G¹¹ may be replaced by a cyclic anhydride.

Preferred ether linkages have the formula
-G⁶-O-G⁷-
wherein G⁶ and G⁷ are as hereinbefore defined, optionally one being absent.

This linkage may be formed by reacting
PSC-G⁶-OH
with 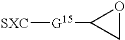
wherein G¹⁵ is C₁₋₄ alkylene and G⁶ is optionally absent and is as hereinbefore defined.

A preferred urethane linkage is 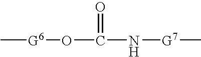
wherein G⁶ and G⁷ are as hereinbefore defined, G⁶ optionally being absent (preferably absent in the configuration PSC-L-SXC)
PSC-G⁶-OH
with
SXC-G⁷-NCO
wherein G⁶ and G⁷ are as hereinbefore defined, G⁶ optionally being absent (preferably absent in the configuration PSC-L-SXC).

The reverse configuration is also possible but the simplest arrangement is PSC-L-SXC and wherein G⁶ is absent. Also most common is when G⁷ is alkylene.

The latter compound is made by reacting
SXC-G⁷-NH₂
(wherein G⁷ is as hereinbefore defined) with phosgene.

Another route is to react
PSC-G⁶-OH
wherein G⁶ is as hereinbefore defined with carbonyl dimidazole to form 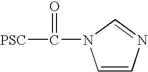
and react that product with
SXC-G⁷-NH₂
wherein G⁷ is as hereinbefore defined.

Preferred triazine linkages have the formula 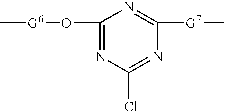
wherein G⁶ and G⁷ are as hereinbefore defined, G⁶ optionally being absent.

These linkages may be formed by reacting
SXC-G⁷-OH
or
SXC-G⁷-NH₂
wherein G⁷ is as hereinbefore defined with cyanuic chloride and then with
PSC-G⁶-OH
wherein G⁶ is as hereinbefore defined but may be absent;
or (reverse -L-) by reacting
   PSC-G⁷-OH
   with cyanuric chloride (when G⁷ is as hereinbefore defined) and then with
   SXC-G⁶-OH
   or
   SXC-G⁶-NH₂

Preferred carbonate linkages have the formula 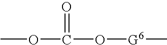
wherein G⁶ is as hereinbefore defined.

This linkage may be formed by reacting
PSC-OH
with SXC-G⁶-OH
in the presence of carbonyl dimidazole or phosgene

Preferred amine linkages have the formula 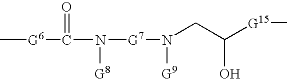
wherein G⁶, G⁷, G⁸, G⁹ and G¹⁵ are as hereinbefore defined.

This linkage may be formed by reacting 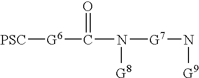
wherein G⁶-G⁹ are hereinbefore defined;
with 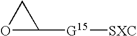
wherein G¹⁵ is as hereinbefore defined.

Preferred ester-alkylene linkages have the formula 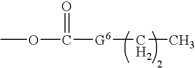
wherein G⁷ is as hereinbefore defined.

These linkages may be prepared by reacting
PSC-OH
with 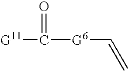
and then reacting with a hydrogen-terminated silicone chain compound (i.e. G⁵=H) over a platinum catalyst.
Emulsions

Compositions according to the present invention can be provided in the form of an emulsion for use in laundry or other fabric treatment compositions.

In a preferred embodiment, the emulsion comprises the polysaccharide having the hydrophobic agent bonded thereto and the sugar polyester, as the dispersed phase.

The emulsions must contain another liquid component as well as the SPE, preferably a polar solvent, such as water. The emulsion has typically from 30 to 99.9%, preferably from 40 to 99% of the other liquid component, preferably a polar solvent, most preferably water. Low water emulsions may be for example 30 to 60% water, preferably 40 to 55% water. High water emulsions may be for example 60 to 99.9% water, preferably 80 to 99% water. Moderate water emulsions may be for example 55 to 80% water.

The emulsion may contain an emulsifying agent, preferably an emulsifying surfactant for the modified polysaccharide/SPE. In preferred cases, the modified polysaccharide is itself an emulsifying agent. In a further preferred case it is the sole emulsifying agent.

The emulsifying agent is especially one or more surfactants, for example, selected from any class, sub class or specific surfactant(s) disclosed herein in any context.

The emulsifying agent most preferably comprises or consists of a non-ionic surfactant. Additionally or alternatively, one or more selected additional surfactants from anionic, cationic, zwitterionic and amphoteric surfactants may be incorporated in or used as the emulsifying agent.

Suitable non-ionic surfactants include the (poly)alkoxylated analogues of saturated or unsaturated fatty alcohols, for example, having from 8 to 22, preferably from 9 to 18, more preferably from 10 to 15 carbon atoms on average in the hydrocarbon chain thereof and preferably on average from 3 to 11, more preferably from 4 to 9 alkyleneoxy groups. Most preferably, the alkyleneoxy groups are independently selected from ethyleneoxy, propyleneoxy and butylenoxy, especially ethyleneoxy and propylenoxy, or solely ethyleneoxy groups and alkyl polyglucosides as disclosed in EP 0 495 176.

Preferably, the (poly)alkoxylated analogues of saturated or unsaturated fatty alcohols, have a hydrophilic-lipophilic balance (HLB) of between 8 to 18.

The HLB of a polyethoxylated primary alcohol nonionic surfactant can be calculated by

$$HLB = \frac{MW ( EO )}{MW ( TOT ) \times 5} \times 100$$

where
MW(EO)=the molecular weight of the hydrophilic part (based on the average number of EO groups)
MW(TOT)=the molecular weight of the whole surfactant (based on the average chain length of the hydrocarbon chain)

This is the classical HLB calculation according to Griffin (J. Soc. Cosmetic Chemists, 5 (1954) 249-256).

For analogous nonionics with a mix of ethyleneoxy (EO), propylenoxy (PO) and/or butyleneoxy (BO) hydrophilic groups, the following formula can be used;

$$HLB = \frac{MW ( EO ) + 0.57 MW ( PO ) + 0.4 MW ( BO )}{MW ( TOT ) \times 5}$$

Preferably, the alkyl polyglucosides may have the following formula;
R—O-Zₙ
in which R is a linear or branched, saturated or unsaturated aliphatic alkyl radical having 8 to 18 carbon atoms or mixtures thereof, and Zₙ is a polyglycosyl radical with n=1.0 to 1.4 hexose or pentose units or mixtures. Preferred examples of alkylpolyglucosides include Glucopon™.

In a composition of a component (especially an emulsion) to be incorporated in a laundry treatment composition as a whole, the weight ratio of modified polysaccharide to emulsifying agent (other than the modified polysaccharide itself) is from 1:30 to 100:1, preferably 1:5 to 10:1. It should be noted that the modified polysaccharide is frequently not a pure material due to incomplete conversion and the ratio of the material as made to the emulsifying agent is typically around 3:1.

Further, in any such composition (especially emulsion components) the weight ratio of SPE to emulsifying agent is from 100:1 to 2:1, preferably from 60:1 to 5:1, more preferably around 33:1 (where the modified polysaccharide is not the sole emulsifying agent).

Emulsion Processing

When in the form of an emulsion, the emulsion is prepared by mixing the modified polysaccharide and the SPE, other liquid component (e.g. water) and preferably, also an emulsifying agent, such as a surfactant, especially a non-ionic surfactant, e.g. in a high shear mixer.

Whether or not pre-emulsified, the modified polysaccharide and SPE composition may be incorporated by admixture with other components of a laundry treatment composition.

Laundry Treatment Compositions

A particularly preferred embodiment of the invention subsists in a laundry treatment composition comprising:
a) from 1 to 60% by weight of the total composition of a surfactant, and
b) from 0.001 to 25% by weight of the total composition of a mixture (preferably an emulsion) comprising a water-soluble or dispersible polysaccharide selected from the group consisting of poly-glucan, poly-mannan, gluco-mannan and mixtures thereof, said polysaccharide having a hydrophobic agent (which may be a silicone) bonded thereto by a hydrolytically stable bond and a sugar polyester.

The composition comprising the modified polysaccharide with SPE is preferably incorporated into laundry compositions as an ingredient to be incorporated in the laundry treatment composition. Such a composition (whether an emulsion or not) may optionally also comprise only a diluent (which may comprise solid and/or liquid) and/or also it may comprise an active ingredient.

The composition of the invention is typically included in said laundry compositions at levels of from 0.001% to 10%, preferably from 0.005% to 5%, most preferably from 0.01% to 3% by weight of the total laundry composition.

If an emulsion is employed, typical inclusion levels of the emulsion in the laundry treatment composition are from 0.01% to 40%, more preferably from 0.001% to 30%, even more preferably from 0.1% to 20%, especially from 1% to 10% by weight of the total composition.

The active ingredient in the compositions is preferably a surface active agent or a fabric conditioning agent. More than one active ingredient may be included. For some applications a mixture of active ingredients may be used.

The compositions of the invention may be in any suitable physical form e.g. a solid such as a powder or granules, a tablet, a solid bar, a paste, gel or liquid, especially, an aqueous based liquid. In particular the compositions may be used in laundry compositions, especially in liquid, powder or tablet laundry composition.

The compositions of the present invention are preferably laundry compositions, especially main wash (fabric washing) compositions or rinse-added softening compositions. Laundry compositions according to the invention may contain at least one further component. The main wash compositions may include a fabric softening agent and rinse-added fabric softening compositions may include surface-active compounds, particularly non-ionic surface-active compounds, if appropriate.

The detergent compositions of the invention may contain a surface-active compound (surfactant) which may be chosen from soap and non-soap anionic, cationic, non-ionic, amphoteric and zwitterionic surface-active compounds and mixtures thereof. Many suitable surface-active compounds are available and are fully described in the literature, for example, in “Surface-Active Agents and Detergents”, Volumes I and II, by Schwartz, Perry and Berch.

The preferred detergent-active compounds that can be used are soaps and synthetic non-soap anionic and non-ionic compounds.

The compositions of the invention may contain linear alkylbenzene sulphonate, particularly linear alkylbenzene sulphonates having an alkyl chain length of C₈-C₁₅. It is preferred if the level of linear alkylbenzene sulphonate is from 0 wt % to 30 wt %, more preferably 1 wt % to 25 wt %, most preferably from 2 wt % to 15 wt %, by weight of the total composition.

The compositions of the invention may contain other anionic surfactants in amounts additional to the percentages quoted above. Suitable anionic surfactants are well-known to those skilled in the art. Examples include primary and secondary alkyl sulphates, particularly C₉-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

The compositions of the invention may also contain non-ionic surfactant. Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkyl-polyglycosides, glycerol monoethers, and polyhydroxyamides (glucamide).

It is preferred if the level of nonionic surfactant is from 0 wt % to 30 wt %, preferably from 1 wt % to 25 wt %, most preferably from 2 wt % to 15 wt %, by weight of the total composition.

Although the preferred embodiments of the present invention include those in which the hydrophobic agent bonded to the polysaccharide is a conditioning and or softening species, any conventional fabric conditioning agent may also be used in the compositions of the present invention. The conditioning agents may be cationic or non-ionic.

If the conventional fabric conditioning compound is to be employed in a main wash detergent composition comprising the polysaccharides of the present invention, the conventional fabric conditioning compound will typically be non-ionic. For use in the rinse phase, the non-polysaccharide conditioner will typically be cationic. These may for example be used in amounts from 0.5% to 35%, preferably from 1% to 30% more preferably from 3% to 25% by weight of the composition.

Suitable cationic fabric softening compounds are substantially water-insoluble quaternary ammonium materials comprising a single alkyl or alkenyl long chain having an average chain length greater than or equal to C₂₀ or, more preferably, compounds comprising a polar head group and two alkyl or alkenyl chains having an average chain length greater than or equal to C₁₄. Preferably the fabric softening compounds have two long chain alkyl or alkenyl chains each having an average chain length greater than or equal to C₁₆. Most preferably at least 50% of the long chain alkyl or alkenyl groups have a chain length of C₁₈ or above. It is preferred if the long chain alkyl or alkenyl groups of the fabric softening compound are predominantly linear.

Quaternary ammonium compounds having two long-chain aliphatic groups, for example, distearyldimethyl ammonium chloride and di(hardened tallow alkyl) dimethyl ammonium chloride, are widely used in commercially available rinse conditioner compositions. Other examples of these cationic compounds are to be found in “Surfactants Science Series” volume 34 ed. Richmond 1990, volume 37 ed. Rubingh 1991 and volume 53 eds. Cross and Singer 1994, Marcel Dekker Inc. New York”.

Any of the conventional types of such compounds may be used in the compositions of the present invention.

The fabric softening compounds are preferably compounds that provide excellent softening, and are characterised by a chain melting L_{β} to L_{α} transition temperature greater than 25° C., preferably greater than 35° C., most preferably greater than 45° C. This L_{β} to L_{α} transition can be measured by differential scanning calorimetry as defined in “Handbook of Lipid Bilayers”, D Marsh, CRC Press, Boca Raton, Fla., 1990 (pages 137 and 337).

Substantially water-insoluble fabric softening compounds are defined as fabric softening compounds having a solubility of less than 1×10⁻³ wt % in demineralised water at 20° C. Preferably the fabric softening compounds have a solubility of less than 1×10⁻⁴ wt %, more preferably from less than 1×10⁻⁸ to 1×10⁻⁶ wt %.

Especially preferred are cationic fabric softening compounds that are water-insoluble quaternary ammonium materials having two C₁₂₋₂₂ alkyl or alkenyl groups connected to the molecule via at least one ester link, preferably two ester links. An especially preferred ester-linked quaternary ammonium material can be represented by the formula: 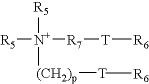
wherein each R₅ group is independently selected from C₁₋₄ alkyl or hydroxyalkyl groups or C₂₋₄ alkenyl groups; each R₆ group is independently selected from C₈₋₂₈ alkyl or alkenyl groups; and wherein R₇ is a linear or branched alkylene group of 1 to 5 carbon atoms, T is 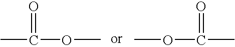
and p is 0 or is an integer from 1 to 5.

Di(tallowoxyloxyethyl) dimethyl ammonium chloride and/or its hardened tallow analogue is an especially preferred compound of this formula.

A second preferred type of quaternary ammonium material can be represented by the formula: 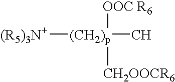
wherein R₅, p and R₆ are as defined above.

A third preferred type of quaternary ammonium material are those derived from triethanolamine (hereinafter referred to as ‘TEA quats’) as described in for example U.S. Pat. No. 3,915,867 and represented by formula:
(TOCH₂CH₂)₃N+(R₉)
wherein T is H or (R₈—CO—) where R₈ group is independently selected from C₈₋₂₈ alkyl or alkenyl groups and R₉ is C₁₋₄ alkyl or hydroxyalkyl groups or C₂₋₄ alkenyl groups. For example N-methyl-N,N,N-triethanolamine ditallowester or di-hardened-tallowester quaternary ammonium chloride or methosulphate. Examples of commercially available TEA quats include Rewoquat WE18 and Rewoquat WE20, both partially unsaturated (ex. WITCO), Tetranyl AOT-1, fully saturated (ex. KAO) and Stepantex VP 85, fully saturated (ex. Stepan).

It is advantageous if the quaternary ammonium material is biologically biodegradable.

Preferred materials of this class such as 1,2-bis(hardened tallowoyloxy)-3-trimethylammonium propane chloride and their methods of preparation are, for example, described in U.S. Pat. No. 4,137,180 (Lever Brothers Co). Preferably these materials comprise small amounts of the corresponding monoester as described in U.S. Pat. No. 4,137,180, for example, 1-hardened tallowoyloxy-2-hydroxy-3-trimethylammonium propane chloride.

Other useful cationic softening agents are alkyl pyridinium salts and substituted imidazoline species. Also useful are primary, secondary and tertiary amines and the condensation products of fatty acids with alkylpolyamines.

The compositions may alternatively or additionally contain water-soluble cationic fabric softeners, as described in GB 2 039 556B (Unilever).

The compositions may comprise a cationic fabric softening compound and an oil, for example as disclosed in EP-A-0829531.

The compositions may alternatively or additionally contain nonionic fabric softening agents such as lanolin and derivatives thereof.

Lecithins and other phospholipids are also suitable softening compounds.

In fabric softening compositions nonionic stabilising agent may be present. Suitable nonionic stabilising agents may be present such as linear C₈ to C₂₂ alcohols alkoxylated with 10 to 20 moles of alkylene oxide, C₁₀ to C₂₀ alcohols, or mixtures thereof. Other stabilising agents include the deflocculating polymers as described in EP 0415698A2 and EP 0458599 B1.

Advantageously the nonionic stabilising agent is a linear C₈ to C₂₂ alcohol alkoxylated with 10 to 20 moles of alkylene oxide. Preferably, the level of nonionic stabiliser is within the range from 0.1 to 10% by weight, more preferably from 0.5 to 5% by weight, most preferably from 1 to 4% by weight of the composition. The mole ratio of the quaternary ammonium compound and/or other cationic softening agent to the nonionic stabilising agent is suitably within the range from 40:1 to about 1:1, preferably within the range from 18:1 to about 3:1.

The composition can also contain fatty acids, for example C₈ to C₂₄ alkyl or alkenyl monocarboxylic acids or polymers thereof. Preferably saturated fatty acids are used, in particular, hardened tallow C₁₆ to C₁₈ fatty acids. Preferably the fatty acid is non-saponified, more preferably the fatty acid is free, for example oleic acid, lauric acid or tallow fatty acid. The level of fatty acid material is preferably more than 0.1% by weight, more preferably more than 0.2% by weight of the total composition. Concentrated compositions may comprise from 0.5 to 20% by weight of fatty acid, more preferably 1% to 10% by weight of the total composition. The weight ratio of quaternary ammonium material or other cationic softening agent to fatty acid material is preferably from 10:1 to 1:10.

It is also possible to include certain mono-alkyl cationic surfactants which can be used in main-wash compositions for fabrics. Cationic surfactants that may be used include quaternary ammonium salts of the general formula R₁R₂R₃R₄N⁺X⁻ wherein the R groups are long or short hydrocarbon chains, typically alkyl, hydroxyalkyl or ethoxylated alkyl groups, and X is a counter-ion (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters).

The choice of surface-active compound (surfactant), and the amount present, will depend on the intended use of the detergent composition. In fabric washing compositions, different surfactant systems may be chosen, as is well known to the skilled formulator, for hand-washing products and for products intended for use in different types of washing machine.

The total amount of surfactant present will also depend on the intended end use and may be as high as 60 wt %, for example, in a composition for washing fabrics by hand. In compositions for machine washing of fabrics, an amount of from 5 to 40% by weight of the total composition is generally appropriate. Typically the compositions will comprise at least 2% surfactant e.g. from 2 to 60%, preferably from 15 to 40% most preferably from 25 to 35% by weight of the total composition.

Detergent compositions suitable for use in most automatic fabric washing machines generally contain anionic non-soap surfactant, or non-ionic surfactant, or combinations of the two in any suitable ratio, optionally together with soap.

The compositions of the invention, when used as main wash fabric washing compositions, will generally also contain one or more detergency builders. The total amount of detergency builder in the compositions will typically range from 5 to 80 wt %, preferably from 10 to 60 wt % based on the total composition.

Inorganic builders that may be present include sodium carbonate, if desired in combination with a crystallisation seed for calcium carbonate, as disclosed in GB 1 437 950 (Unilever); crystalline and amorphous aluminosilicates, for example, zeolites as disclosed in GB 1 473 201 (Henkel), amorphous aluminosilicates as disclosed in GB 1 473 202 (Henkel) and mixed crystalline/amorphous aluminosilicates as disclosed in GB 1 470 250 (Procter & Gamble); and layered silicates as disclosed in EP 164 514B (Hoechst). Inorganic phosphate builders, for example, sodium orthophosphate, pyrophosphate and tripolyphosphate are also suitable for use with this invention.

The compositions of the invention preferably contain an alkali metal, preferably sodium, aluminosilicate builder. Sodium aluminosilicates may generally be incorporated in amounts of from 10 to 70% by weight (anhydrous basis), preferably from 25 to 50 wt %.

The alkali metal aluminosilicate may be either crystalline or amorphous or mixtures thereof, having the general formula: 0.8-1.5Na₂O.Al₂O₃.0.8-6SiO₂

These materials contain some bound water and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature. Suitable crystalline sodium aluminosilicate ion-exchange detergency builders are described, for example, in GB 1 429 143 (Procter & Gamble). The preferred sodium aluminosilicates of this type are the well-known commercially available zeolites A and X, and mixtures thereof.

The zeolite may be the commercially available zeolite 4A now widely used in laundry detergent powders. However, according to a preferred embodiment of the invention, the zeolite builder incorporated in the compositions of the invention is maximum aluminium zeolite P (zeolite MAP) as described and claimed in EP 384 070A (Unilever). Zeolite MAP is defined as an alkali metal aluminosilicate of the zeolite P type having a silicon to aluminium weight ratio not exceeding 1.33, preferably within the range of from 0.90 to 1.33, and more preferably within the range of from 0.90 to 1.20.

Especially preferred is zeolite MAP having a silicon to aluminium weight ratio not exceeding 1.07, more preferably about 1.00. The calcium binding capacity of zeolite MAP is generally at least 150 mg CaO per g of anhydrous material.

Organic builders that may be present include polycarboxylate polymers such as polyacrylates, acrylic/maleic copolymers, and acrylic phosphinates; monomeric polycarboxylates such as citrates, gluconates, oxydisuccinates, glycerol mono-, di and trisuccinates, carboxymethyloxy succinates, carboxymethyloxymalonates, dipicolinates, hydroxyethyliminodiacetates, alkyl- and alkenylmalonates and succinates; and sulphonated fatty acid salts. This list is not intended to be exhaustive.

Especially preferred organic builders are citrates, suitably used in amounts of from 5 to 30 wt %, preferably from 10 to 25 wt %; and acrylic polymers, more especially acrylic/maleic copolymers, suitably used in amounts of from 0.5 to 15 wt %, preferably from 1 to 10 wt %.

Builders, both inorganic and organic, are preferably present in alkali metal salt, especially sodium salt, form.

Compositions according to the invention may also suitably contain a bleach system. Fabric washing compositions may desirably contain peroxy bleach compounds, for example, inorganic persalts or organic peroxyacids, capable of yielding hydrogen peroxide in aqueous solution.

Suitable peroxy bleach compounds include organic peroxides such as urea peroxide, and inorganic persalts such as the alkali metal perborates, percarbonates, perphosphates, persilicates and persulphates. Preferred inorganic persalts are sodium perborate monohydrate and tetrahydrate, and sodium percarbonate.

Especially preferred is sodium percarbonate having a protective coating against destabilisation by moisture. Sodium percarbonate having a protective coating comprising sodium metaborate and sodium silicate is disclosed in GB 2 123 044B (Kao).

The peroxy bleach compound is suitably present in an amount of from 0.1 to 35 wt %, preferably from 0.5 to 25 wt %. The peroxy bleach compound may be used in conjunction with a bleach activator (bleach precursor) to improve bleaching action at low wash temperatures. The bleach precursor is suitably present in an amount of from 0.1 to 8 wt %, preferably from 0.5 to 5 wt %.

Preferred bleach precursors are peroxycarboxylic acid precursors, more especially peracetic acid precursors and pernoanoic acid precursors. Especially preferred bleach precursors suitable for use in the present invention are N,N,N′,N′,-tetracetyl ethylenediamine (TAED) and sodium nonanoyloxybenzene sulphonate (SNOBS). The novel quaternary ammonium and phosphonium bleach precursors disclosed in U.S. Pat. No. 4,751,015 and U.S. Pat. No. 4,818,426 (Lever Brothers Company) and EP 402 971A (Unilever), and the cationic bleach precursors disclosed in EP 284 292A and EP 303 520A (Kao) are also of interest.

The bleach system can be either supplemented with or replaced by a peroxyacid. examples of such peracids can be found in U.S. Pat. No. 4,686,063 and U.S. Pat. No. 5,397,501 (Unilever). A preferred example is the imido peroxycarboxylic class of peracids described in EP A 325 288, EP A 349 940, DE 382 3172 and EP 325 289. A particularly preferred example is phthalimido peroxy caproic acid (PAP). Such peracids are suitably present at 0.1-12%, preferably 0.5-10%.

A bleach stabiliser (transition metal sequestrant) may also be present. Suitable bleach stabilisers include ethylenediamine tetra-acetate (EDTA), the polyphosphonates such as Dequest (Trade Mark) and non-phosphate stabilisers such as EDDS (ethylene diamine di-succinic acid). These bleach stabilisers are also useful for stain removal especially in products containing low levels of bleaching species or no bleaching species.

An especially preferred bleach system comprises a peroxy bleach compound (preferably sodium percarbonate optionally together with a bleach activator), and a transition metal bleach catalyst as described and claimed in EP 458 397A, EP 458 398A and EP 509 787A (Unilever).

Bleach systems may comprise transition metal catalyst systems such as those disclosed in WO9965905; WO0012667; WO0012808; WO0029537, and, WO0060045. These catalyst systems have the advantage that they require no added peroxyl compounds and can work, directly or indirectly, using atmospheric oxygen.

The compositions according to the invention may also contain one or more enzyme(s). Suitable enzymes include the proteases, amylases, cellulases, oxidases, peroxidases and lipases usable for incorporation in detergent compositions.

Preferred proteolytic enzymes (proteases) are, catalytically active protein materials which degrade or alter protein types of stains when present as in fabric stains in a hydrolysis reaction. They may be of any suitable origin, such as vegetable, animal, bacterial or yeast origin.

Proteolytic enzymes or proteases of various qualities and origins and having activity in various pH ranges of from 4-12 are available and can be used in the instant invention.

Examples of suitable proteolytic enzymes are the subtilisins which are obtained from particular strains of B. Subtilis B. licheniformis, such as the commercially available subtilisins Maxatase (Trade Mark), as supplied by Genencor International N.V., Delft, Holland, and Alcalase (Trade Mark), as supplied by Novozymes Industri A/S, Copenhagen, Denmark.

Particularly suitable is a protease obtained from a strain of Bacillus having maximum activity throughout the pH range of 8-12, being commercially available, e.g. from Novozymes Industri A/S under the registered trade-names Esperase (Trade Mark) and Savinase (Trade-Mark). The preparation of these and analogous enzymes is described in GB 1 243 785. Other commercial proteases are Kazusase (Trade Mark obtainable from Showa-Denko of Japan), Optimase (Trade Mark from Miles Kali-Chemie, Hannover, West Germany), and Superase (Trade Mark obtainable from Pfizer of U.S.A.).

Detergency enzymes are commonly employed in granular form in amounts of from about 0.1 to about 3.0 wt %. However, any suitable physical form of enzyme may be used.

The combination of non-cellulose polysaccharides and cellulase enzymes is particularly useful, as these enzymes exhibit reduced activity against this class of polysaccharides, as compared to their activity against cellulose. Cellulase is known to be useful and is used in laundry products for de-fuzzing and colour brightening.

The compositions of the invention may contain alkali metal (preferably sodium) carbonate, in order to increase detergency and ease processing. Sodium carbonate may suitably be present in amounts ranging from 1 to 60 wt %, preferably from 2 to 40 wt %. However, compositions containing little or no sodium carbonate are also within the scope of the invention.

Powder flow may be improved by the incorporation of a small amount of a powder structurant, for example, a fatty acid (or fatty acid soap), a sugar, an acrylate or acrylate/maleate copolymer, or sodium silicate. One preferred powder structurant is fatty acid soap, suitably present in an amount of from 1 to 5 wt %.

Other materials that may be present in detergent compositions of the invention include sodium silicate; anti-redeposition agents such as cellulosic polymers; soil release polymers; inorganic salts such as sodium sulphate; or lather boosters as appropriate; dyes; coloured speckles; fluorescers and decoupling polymers. This list is not intended to be exhaustive. However, many of these ingredients will be better delivered as benefit agent groups in materials according to the first aspect of the invention.

The detergent composition when diluted in the wash liquor (during a typical wash cycle) will typically give a pH of the wash liquor from 7 to 10.5 for a main wash detergent.

Particulate detergent compositions are suitably prepared by spray-drying a slurry of compatible heat-insensitive ingredients, and then spraying on or post-dosing those ingredients unsuitable for processing via the slurry. The skilled detergent formulator will have no difficulty in deciding which ingredients should be included in the slurry and which should not.

Particulate detergent compositions of the invention preferably have a bulk density of at least 400 g/l, more preferably at least 500 g/l. Especially preferred compositions have bulk densities of at least 650 g/litre, more preferably at least 700 g/litre.

Such powders may be prepared either by post-tower densification of spray-dried powder, or by wholly non-tower methods such as dry mixing and granulation; in both cases a high-speed mixer/granulator may advantageously be used. Processes using high-speed mixer/granulators are disclosed, for example, in EP 340 013A, EP 367 339A, EP 390 251A and EP 420 317A (Unilever).

Liquid detergent compositions can be prepared by admixing the essential and optional ingredients thereof in any desired order to provide compositions containing components in the requisite concentrations. Liquid compositions according to the present invention can also be in compact form which means it will contain a lower level of water compared to a conventional liquid detergent.

Product Forms

Product forms include powders, liquids, gels, tablets, any of which are optionally incorporated in a water-soluble or water dispersible sachet. The means for manufacturing any of the product forms are well known in the art. If the composition comprising the modified polysaccharide and SPE is to be incorporated in a powder (optionally the powder to be tableted), and whether or not pre-emulsified, it is optionally included in a separate granular component, e.g. also containing a water soluble organic or inorganic material, or in encapsulated form.

Substrate

The substrate may be any substrate onto which it is desirable to deposit SPE and which is subjected to treatment such as a washing or rinsing process.

In particular, the substrate may be a textile fabric. It has been found that particular good results are achieved when using a natural fabric substrate such as cotton, or fabric blends containing cotton.

Treatment

The treatment of the substrate with the material of the invention can be made by any suitable method such as washing, soaking or rinsing of the substrate.

Typically the treatment will involve a washing or rinsing method such as treatment in the main wash or rinse cycle of a washing machine and involves contacting the substrate with an aqueous medium comprising the material of the invention.

### EXAMPLES

The present invention will now be explained in more detail by reference to the following non-limiting examples.

In the following examples where percentages are mentioned, this is to be understood as percentage by weight. In the following tables where the values do not add up to 100 these are to be understood as parts by weight.

### Example 1

### Synthesis of Cellulose Monoacetate (CMA) with Grafted Silicone

Monocarboxydecyl terminated polydimethylsiloxane (PDMS) source (Molecular weight 5,000: 1.5 g, 0.23 mmols) was dispersed in dimethylacetamide (10 cm³) by vigorous stirring under nitrogen. Carbonyldiimidazole (37 mg, 0.23 mmols) was then added and the dispersion heated with stirring to 70° C. under nitrogen for two hours. A solution of cellulose monoacetate (DS 0.58; 1 g, 5.3 mmol equivalents based on primary hydroxyl groups) in dimethylacetamide (10 cm³) was then added and stirring and heating was continued for a further 20 hours. Following this time the mixture was filtered and the filtrate added to vigorously stirred acetone to give a white precipitate. This precipitate was filtered off, washed with acetone and dried under vacuum to give a white polymer (1.01 g). From the ¹H NMR of the polymer (after hydrolysis with 20% DCl in D₂O for two hours at 80° C.) and normalising the integration of the anomeric protons to unity and the acetate group to 0.58 the integration of the Si—CH₃ group (at 0.0 ppm) gives an overall degree of substitution (DS) of siloxane groups of 0.0015. This material is hereinafter referred to as “Polymer A”.

### Example 2

### Preparation of Locust Bean Gum with Grafted Silicone

Lithium chloride (27 g) was dissolved in anhydrous dimethyl sulfoxide (300 cm³) with heating (150° C.) and stirring under nitrogen. Once the lithium chloride was dissolved the solution was cooled to 120° C. before slowly adding locust bean gum (3.5 g) over a period of 20 minutes with vigorous stirring.

The viscous solution thus obtained was then further cooled to 70° C. and carbonyl diimidazole (54 mg, 0.5 mmols) was added and stirring and heating was continued for a further two hours. Diaminopropyl terminated polydimethylsiloxane (3,000 mwt, 1 g, 0.33 mmols) was then added and the solution stirred with heating for 18 hours.

The solution was cooled to room temperature before adding drop-wise to vigorously stirred acetone (3 litres) to precipitate the polymer. The suspension was centrifuged to isolate the product which was then washed with acetone (2×200 cm³) before drying under vacuum (40° C.) overnight to give an off-white solid (3.1 g).

From the ¹H NMR of the hydrolysed product (heated to 1 hour at 70° C. in 20% DCl/D₂O) the degree of substitution of PDMS groups to sugar units was found to be 5.3×10⁻⁴. This material is hereinafter referred to as “Polymer B”.

### Examples 3 and 4

### Preparation of Sucrose Polyester Emulsions

Emulsions were prepared as using the formulations shown in Table 1.

TABLE 1

| | Parts | | |
|---|---|---|---|
| Ingredient | Example 3 | Example 4 | Control ¾ |
| Polymer A | 36 | 0 | 0 |
| Polymer B | 0 | 36 | 0 |
| ER-290* | 360 | 360 | 360 |
| Water | 10000 | 10000 | 10000 |

*ER-290 is an sucrose tetra erucate Ryoto ™ sugar ester from Mitsubishi-Kagaku Foods Corporation

Polymer A or B was weighed into a bottle along with 10 cm³ of water. This mixture was agitated using an ultrasonic probe (Soniprobe™) at half power until no undissolved polymer was visible (2-3 minutes). The ER-290 was then added to the bottle. The mixture was further agitated with the ultrasonic probe (1 minute at setting 6 followed by 2×1 minute at setting 8) to produce the emulsion. The same process was used to produce the control emulsion but no polymer was used.

### Example 5

### Treatment of Fabrics with Detergent Composition Containing Emulsion Example 3

Wash liquors were prepared by adding 2.84 g of the formulations given in Table 2 to 150 cm³ of water.

TABLE 2

Quantity/%

| Ingredient | Example 5 | Control 5A |
|---|---|---|
| Sodium LAS spray-dried | 17.6 | 17.6 |
| 100% | | |
| Nonionic 7EO, branched | 17.6 | 17.6 |
| Trisodium citrate | 3.1 | 3.1 |
| Sodium carbonate | 5.1 | 5.1 |
| Sodium Bicarbonate | 0.9 | 0.9 |
| Sodium sulphate | 19.3 | 19.3 |
| Emulsion Example 3 | 36.5 | 0.0 |
| Emulsion Control ¾ | 0.0 | 36.5 |

The wash liquors were placed in separate pots of a Rotawash™ Colour Fastness Tester (ex SDL, UK and as described in ISO 105) that had been preheated to 40° C. To each pot was added a piece of white 100% cotton terry towelling weighing 18 g along with 25 stainless steel balls. The pots were sealed and then washed for 45 minutes with end over end agitation at 40 rpm. At the end of the wash period, the liquor was decanted from each of the pots, which were then refilled with 250 cm³ of water, resealed, replaced in the Rotawash and washed for a further ten minutes. This rinse step was repeated one more time after which, the rinse liquor was decanted from the pots, the cloths gently squeezed by hand to remove excess water and the fabrics dried flat overnight under ambient conditions. Each condition was run in duplicate.

The quantity of SPE deposited onto the fabrics during the wash was then determined as follows. Each fabric piece was cut into three and the individual pieces weighed. Each fabric piece was added to a bottle containing 50 cm³ of tetrahydrofuran (THF) and the deposited SPE extracted with the aid of ultrasonication for five minutes. The amount of SPE extracted was determined by gel permeation chromatography (GPC) using a PLgel 3 μm 100 Å column with THF eluent and an evaporative light scattering detector ELS 1000 light scattering detector. The area under the elution peak for the SPE was calculated by integration of the trace and this area was used to calculate the concentration of SPE in the THF solution from the extraction by comparison to a calibration curve produced using SPE in THF standards. The results from the three portions of cloth were used to calculate an average value for the amount of SPE deposited on the fabric expressed as milligrams of SPE deposited per gram of fabric. These results are tabulated below in Table 3.

TABLE 3

| | SPE deposited/ |
|---|---|
| | Mg per g of fabric |
| Example 5 | 0.133 ± 0.033 |
| Control 5A | 0.075 ± 0.012 |

It will be seen that deposition of SPE onto fabric was dramatically increased from the composition in accordance with the invention.

### Example 6

### Treatment of Fabrics with Detergent Composition Containing Emulsion Example 4

Wash liquors were prepared by adding 2.84 g of the formulations given in Table 4 to 150 cm³ of water.

TABLE 4

Quantity/%

| Ingredient | Example 6 | Control 6A |
|---|---|---|
| Sodium LAS spray-dried | 17.6 | 17.6 |
| 100% | | |
| Nonionic 7EO, branched | 17.6 | 17.6 |
| Trisodium citrate | 3.1 | 3.1 |
| Sodium carbonate | 5.1 | 5.1 |
| Sodium Bicarbonate | 0.9 | 0.9 |
| Sodium sulphate | 19.3 | 19.3 |
| Emulsion Example 4 | 36.5 | 0.0 |
| Emulsion Control ¾ | 0.0 | 36.5 |

The wash liquors were placed in separate pots of a Rotawash™ Colour Fastness Tester (ex SDL, UK and as described in ISO 105) at ambient temperature. To each pot was added a piece of white 100% cotton terry towelling weighing 18 g along with 25 stainless steel balls. The pots were sealed and then washed for 45 minutes with end over end agitation at 40 rpm. At the end of the wash period, the liquor was decanted from each of the pots, which were then refilled with 250 cm³ of water, resealed, replaced in the Rotawash and washed for a further ten minutes. The rinse liquor was decanted from the pots, the cloths gently squeezed by hand to remove excess water and the fabrics dried flat overnight under ambient conditions. Each condition was run in duplicate.

The quantity of SPE deposited onto the fabrics during the wash was then determined as follows. Each fabric piece was cut into four and the individual pieces weighed. Each fabric piece was added to a bottle containing 50 cm³ of tetrahydrofuran (THF) and the deposited SPE extracted with the aid of ultrasonication for five minutes. The amount of SPE extracted was determined by gel permeation chromatography (GPC) using a PLgel 3 μm 100 Å column with THF eluent and an evaporative light scattering detector ELS 1000 light scattering detector. The area under the elution peak for the SPE was calculated by integration of the trace and this area was used to calculate the concentration of SPE in the THF solution from the extraction by comparison to a calibration curve produced using SPE in THF standards. The results from the three portions of cloth were used to calculate an average value for the amount of SPE deposited on the fabric expressed as milligrams of SPE deposited per gram of fabric. These results are given below in Table 5.

TABLE 5

| | SPE deposited/ |
|---|---|
| | Mg per g of fabric |
| Example 5 | 0.205 ± 0.037 |
| Control 5A | 0.143 ± 0.026 |

It will be seen that deposition of SPE onto fabric was greatly increased from the composition in accordance with the invention.

1. A composition comprising:
(a) a water-soluble or dispersible polysaccharide having a hydrophobic agent bonded thereto by a hydrolytically stable bond and
(b) a sugar polyester (SPE).

2. A composition according to claim 1 wherein the polysaccharide has a backbone comprising β₁₋₄ linkages.

3. A composition according to claim 2 wherein the polysaccharide backbone is a poly-glucan, poly-mannan, gluco-mannan or a mixture thereof.

4. A composition according to claim 3 wherein the polysaccharide is a galacto-mannan, xylo-glucan or a mixture thereof.

5. A composition according to claim 4 wherein the polysaccharide is locust bean gum, tamarind xyloglucan, guar gum or mixture thereof.

6. A composition according to claim 1 wherein the polysaccharide is cellulose monoacetate.

7. A composition according to claim 1 wherein the hydrophobic agent is selected from the group consisting of silicone, hydrocarbon and hydrophobic polymer.

8. A composition according to claim 1 wherein the sugar polyester is selected from the group consisting of sucrose polyesters, glucose polyesters and cellobiose polyesters.

9. A composition according to claim 8 wherein the sugar polyester is a sucrose polyester.

10. A composition according to claim 1 wherein some of the sugar polyester is bonded to the polysaccharide by a chemical bond.

11. A composition according to claim 10, wherein the ratio of sugar polyester which is bonded to the polysaccharide by a chemical bond to that sugar polyester which is not bonded by a chemical bond is in the range of from 1:1000 to 1:1, preferably from 1:200 to 1:4.

12. A composition according to claim 1 wherein the ratio of the polysaccharide with hydrophobic agent bonded thereto to the sugar polyester is in the range of from 1:200 to 1:5 parts by weight, preferably from 1:20 to 1:8 parts by weight of the composition.

13. A composition as claimed in claim 1 comprising the polysaccharide having the hydrophobic agent bonded thereto and the sugar polyester, as the dispersed phase of an emulsion.

14. A composition as claimed in claim 13 further comprising an emulsifying agent.

15. A composition as claimed in claimed in claim 14 wherein the emulsifying agent comprises a non-ionic surfactant.

16. A composition as claimed in claim 13 wherein the emulsion is from 30 to 99.9%, preferably from 40 to 99% of another liquid component, preferably a polar solvent, most preferably water.

17. A composition as claimed in claim 1 wherein the hydrophobic agent is a silicone selected from polydialkyl siloxanes, amine derivatives thereof, and mixtures thereof wherein the silicone comprises silicone chains.

18. A composition as claimed in claim 17, wherein the average degree of substitution of the silicone chain(s) on the polysaccharide is from 0.00001 to 0.5, preferably 0.0001 to 0.5, more preferably from 0.001 to 0.1 and even more preferably from 0.001 to 0.05.

19. A composition as claimed in claim 18, wherein the silicone chain(s) in the polysaccharide is or are independently selected from those of formula: 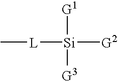
wherein L is absent or is a linking group and one or two of substituents G¹-G³ is a methyl group, the remainder being selected from groups of formula 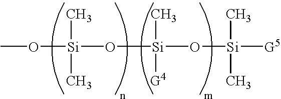
the —Si(CH₃)₂O— groups and the —Si(CH₃O)(G⁴)- groups being arranged in random or block fashion, but preferably random.
wherein n is from 5 to 1000, preferably from 10 to 200 and m is from 0 to 100, preferably from 0 to 20, for example from 1 to 20.
G⁴ is selected from groups of formula:
—(CH₂)ₚ—CH₃, where p is from 1 to 18
—(CH₂)_{q}—NH—(CH₂)ᵣ, —NH₂ where q and r are independently from 1 to 3
—(CH₂)ₛ—NH₂, where s is from 1 to 3 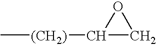
where t is from 1 to 3
—(CH₂)ᵤ—COOH, where u is from 1 to 10, 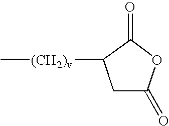
where v is from 1 to 10, and
—(CH₂ CH₂O)_{w}—(CH₂)ₓH, where w is from 1 to 150, preferably from 10 to 20 and x is from 0 to 10;
and G⁵ is independently selected from hydrogen, groups defined above for G⁴, —OH, —CH₃ and —C(CH₃)₃.

20. A composition as claimed in claim 19, where L is selected from amide linkages, ester linkages, ether linkages, urethane linkages, triazine linkages, carbonate linkages, amine linkages and ester-alkylene linkages.

21. A laundry treatment composition comprising a composition as claimed in claim 1 and at least one further component.

22. A laundry treatment composition as claimed in claim 21, wherein the further component comprises a surfactant.

23. A laundry treatment composition comprising: from 1 to 60% by weight of the total composition of a surfactant, and from 0.001 to 25% by weight of the total composition of an emulsion comprising (a) a water-soluble or dispersible polysaccharide selected from the group consisting of poly-glucan, poly-mannan, gluco-mannan and mixtures thereof, said polysaccharide having a hydrophobic agent bonded thereto by a hydrolytically stable bond, and (b) a sugar polyester.

24. A laundry treatment composition according to claim 23 wherein the hydrophobic agent is silicone.

25. A method for depositing a sugar polyester onto a substrate, the method comprising, contacting in an aqueous medium, the substrate and a composition according to claim 1.

26. Use of a composition as claimed in claim 1 in a laundry treatment composition to provide a softening benefit to a substrate.
